(19) United States
(12) Patent Application Publication
(10) Pub. No.: US 2005/0199262 A1
(43) Pub. Date: Sep. 15, 2005

(54) Method for ashing

(76) Inventors: Jong-Po Jeon, Ansung-city (KR); Yong-Hoon Song, Pyungtaek-city (KR); Jin-Woo Park, Pyungeak-city (KR); Seung-Bok Yang, Pyungtaek-city (KR)

Correspondence Address: HARNESS, DICKEY & PIERCE, P.L.C., P.O. BOX 8910, RESTON, VA, 20195, US

(21) Appl. No.: 10/510,602

(22) PCT Filed: Oct. 7, 2002
(86) PCT No.: PCT/KR02/01868

§ 371 Date: May 13, 2005

(30) Foreign Application Priority Data
Apr. 19, 2002 (KR) 2002/21538

(51) Int. Cl. B08B 6/00

(52) U.S. Cl. 134/1.1; 134/26

(57) ABSTRACT

The present invention provides an ashing method using rapid heat transfer under high pressure. The present method, applicable to all photoresist ashing processes, can rapidly remove hardened photoresists without popping at the ashing step by baking high dose ion implanted silicon substrate on a hot plate, enhancing the ashing quantity, by drastically reducing the ashing process time, while allowing conventional equipments to be used further. The present method comprises an in situ baking step, wherein a silicon substrate is baked for a predetermined time period under a pressure of 10 Torr or more while it is placed on a hot plate; a vacuumizing step, wherein a stable vacuum status is achieved while the silicon substrate is placed on the hot plate; a gas processing step, wherein selected reaction gas is introduced into a reaction chamber; and an ashing step, wherein plasma is generated until almost all of the photoresists are removed.

### TECHNICAL FIELD OF THE INVENTION

The present invention relates to a method for ashing, and in particular, to a semiconductor wafer ashing method, wherein a semiconductor substrate is baked in a high temperature on a hot plate and the hardened photoresists are rapidly removed without popping at the step of ashing, allowing an enhancement of the ashing quantity through a drastic reduction of the time required for a wafer ashing process, while allowing further use of a conventional ashing equipment.

### BACKGROUND OF THE INVENTION

A photo lithography process, which is one of manufacture processes of semiconductor devices, comprises the steps of spin coating of photoresists for the purpose of forming a photoresist layer on a semiconductor substrate; of selective exposuring of the photoresist layer; of developing the exposed photoresist layer to form a photoresist pattern; of etching or introducing impurities to areas of the semiconductor substrate not covered by the photoresist and of ashing process in which the photoresist pattern used as a mask in the dopant implantation step is removed.

An ashing process using plasma comprising an oxygen base or an oxygen ion is a process for removal of photoresist pattern. A conventional ashing process is carried out by introducing plasma in a reaction chamber, in which a wafer has been heated under low pressure via an appropriate heating means. Since an ashing rate in an ashing process is proportional to the temperature, ashing processes were carried out in high temperatures. Actually, between 80° C. and 300° C., the photoresists are changed drastically to activated energy state in proportion to the increase of temperature, while the activated energy decreases at temperatures over 300° C.

In particular, the material on the upper layer of the photoresist pattern undergoes a chemical change at the step of ion implantation, to become hardened. An ashing process after the ion implantation is carried out in a high temperature as described above, and the phenomenon of popping occurs at a temperature of ca. 120° C. or over, wherein the hardened photoresist layer is destroyed due to the expansion of the evaporated material at the lower part of the hardened photoresist. Such phenomenon is highly undesirable, for popping causes contamination of the wafer surface as well as the inner surface of the ashing equipment and rejection of the wafer, resulting in raising of the production costs and a lowering of productivity by extending the process time. On the other hand, performing an ashing process at a low temperature to avoid such popping would result in a lower ashing efficiency, because such a process requires a longer processing time.

A conventional ashing equipment removes hard photoresists in a low temperature using a lamp heating device as illustrated in FIG. 1, and then, removes the remaining soft photoresists by bringing the semiconductor substrate to a high temperature.

FIG. 2 illustrates a method of removing photoresists after the conventional ion implantation, in the initial step of which process (210) O₂ gas, N₂ gas, and CF₄ gas are filled in a reactor and a vacuum degree of about 1 Torr to 10 Torr is maintained. In the first ashing step (220), a semiconductor substrate is heated to reach a temperature of 100° C. to 150° C. using a lamp or a hot plate and then, the hard photoresists are removed. In the second ashing step (230), the remaining soft resists are removed. The numeral 240 in FIG. 2 indicates temperature change of the wafer. Further, the numeral 250, being a graph indicating the generated gas caused by the above reaction, shows quantity of the removed photoresists via quantity of the gas generated by the above photoresists removing reaction.

An ashing process for a dose ion implanted silicon substrate is also possible with a conventional ashing equipment. However, problems with such a procedure are that as diameter of the silicon substrate getting greater, the equipment cost increases and that a more complicated electric as well as mechanical structures are necessary for maintenance of such an equipment. Accordingly, the unit price relative to the productivity rises.

### DETAILED DESCRIPTION OF THE INVENTION

The present invention, conceived to solve the aforementioned problems, aims to provide a semiconductor wafer ashing method capable of removing effectively and rapidly hardened hard photoresists without popping.

Another objective of the present invention is to provide a semiconductor wafer ashing method which can enhance the efficiency of the ashing process.

In order to achieve the above objectives, the prpesent invention provides an ashing method comprising a first step, wherein a silicon substrate is in situ baked while it is put on a high-temperature hot plate, and a subsequent ashing step, wherein soft photoresists as well as hard photoresists are ashed simultaneously, using plasma. The present invention, being applicable to any photoresist ashing process, shows especially high efficiency with dose ion implanted silicon substrates.

The ashing method in accordance with the present invention comprises, in contrast to the conventional ashing method, an additional step of in situ baking (300-1) of a silicon substrate under high pressure prior to the step of ashing, as shown in FIG. 3. The process proceeds further, under conditions similar to those of the conventional method, to a vacuum processing step (300-2) and to a gas processing step (300-3). In the step of ashing (310), following the in situ baking step (300-1), the vacuum processing step (300-2) and the gas processing step (300-3), the hard photoresists are removed at once together with the soft photoresists in a process using the power of plasma. Moreover, an over-ashing step (320) may be added to ensure complete removal of the entire photoresists.

### BRIEF DESCRIPTION OF THE DRAWINGS

FIG. 1 shows the construction of a prior art silicon substrate ashing equipment.

FIG. 2 shows a process sequence chart based on the temperature of a conventional dose ion implanted silicon substrate.

FIG. 3 shows a process sequence chart based on the temperature of a dose ion implanted silicon substrate in accordance with the present invention.

FIGS. 4 through 8 are schematic diagrams showing removal of photoresists in the course of the ashing process on a dose ion implanted silicon substrate in accordance with the present invention.

FIG. 9 shows SEM photos of a via-etching substrate after an ashing process in accordance with the conventional method.

FIG. 10 shows SEM photos of a via-etching substrate after an ashing process in accordance with the present invention.

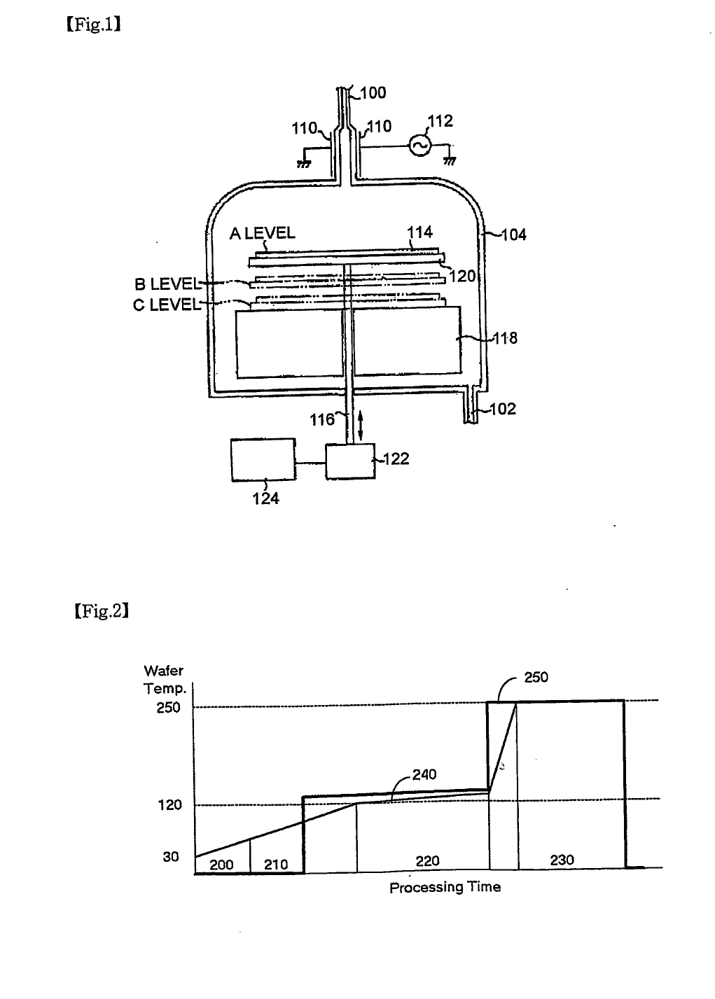

### DESCRIPTION OF THE PREFERRED EMBODIMENTS

A description of the preferred embodiments of the present invention is given below making reference to the accompanying drawings, for a more clear understanding of the present invention.

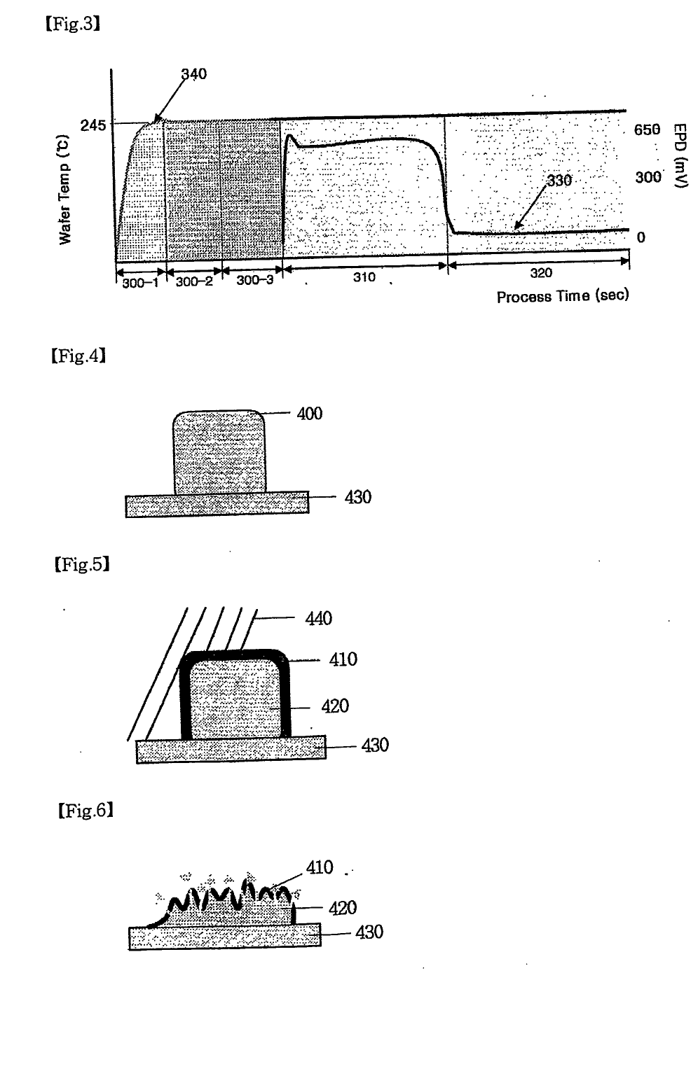

A semiconductor wafer ashing method as per the present invention proceeds in sequences as illustrated in FIG. 3.

In the in situ baking step (300-1), the photoresists are removed based on the fact that, when a silicon substrate is put on a high-temperature hot plate in a high pressure reaction chamber, the soft photoresists are so rapidly contracted that no thermal expansion occurs. To elaborate, the substrate is put on a hot plate with a temperature from 200° C. to 300° C. under a pressure of 10 Torr or more, and maintained for a predetermined period of time. The maintenance time at this step of in situ baking, though it may be set appropriately depending on the substrate conditions such as quantity of the doping, is preferably five to twenty seconds, in which case temperature of the substrate rises steeply as shown in FIG. 3.

Especially, once five seconds have elapsed after a dose ion implanted wafer was put on a high-temperature hot plate, the soft photoresists contract, color of the photoresists changes, and no popping occurs. Since the soft photoresists contain volatile materials, such volatile materials shall completely be extinguished through a baking of twenty seconds or less prior to a plasma generation.

At the step of vacuum processing (300-2), the reaction chamber is brought to a stable vacuum status while the silicon substrate is put on a high-temperature hot plate. The temperature change of the silicon plate during this procedure is as shown in FIG. 3. This step is performed in conditions similar to the conventional methods.

At the step of gas processing (300-3), processing gas is introduced into the reaction chamber while the silicon substrate is put on a high-temperature hot plate to reach a level of pressure appropriate to the processing conditions, and then the pressure is maintained. The temperature change of the silicon plate during this procedure is as shown in FIG. 3. The processing gas used here may be the same as that used in a conventional ashing method.

No plasma is used in any of the above steps: the high-pressure processing step (300-1), the vacuum processing step (300-2), and the gas processing step (300-3).

At the ashing step (310) the process proceeds by generating plasma while the temperature of the silicon substrate put on a high-temperature hot plate maintains a high level. Here, the processing conditions are the same as those in the second ashing step of a conventional ashing method, with the difference that the hard photoresists 410 are removed together with the soft photoresists 420 at this step in the method of the present invention.

The step of over-ashing (320), which is for providing a margin, has the same processing conditions as the ashing step (310).

Further, from the gas generation graph (330) illustrating the gas generated during the photoresists removal reaction, it can be seen that the quantity of gas generated by the chemical reaction maintains over a certain level at the step of ashing (310), while it is reduced at the step of over-ashing (320), where almost all of the photoresists have already been removed.

Temperature of the silicon substrate (340) rises rapidly at the step of in situ baking (300) and maintains a high level at the step of ashing (310) as shown in FIG. 3.

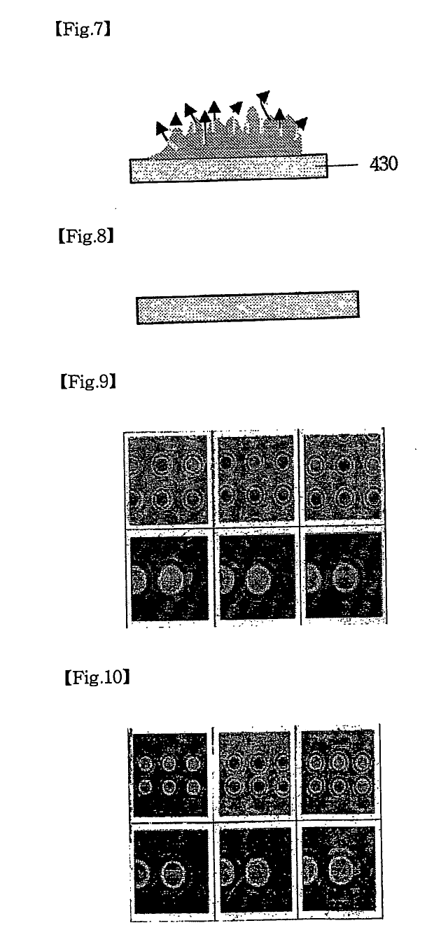

FIGS. 4 through 8 are diagrams showing removal of photoresists 400 in the course of the ashing process on a dose ion implanted silicon substrate 430 in accordance with the present invention. FIG. 4 shows a photoresist 400 as coated on a silicon substrate at a step prior to the in situ baking step (300). FIG. 5 shows an ion implantation procedure of a dopant 440 containing P, B, or As on a silicon substrate 430 at a step prior to the in situ baking step (300). FIG. 6 shows the step of in situ baking (300) after implantation of a dopant, wherein hard photoresists 410 as well as soft photoresists 420 coexist on the silicon substrate 430. FIG. 7 shows a state, in which the hard photoresists 410 are removed at the ashing step (310), while FIG. 8 shows a state, in which the soft photoresists 420 are removed.

Next, it was confirmed as to whether any popping had occurred on the dose ion implanted silicon substrate while the ashing method as per the present invention was carried out. The experiment conditions for such confirmation and the results are shown in Table 1 below.

TABLE 1

| | In situ | In situ | | | | | | |
|---|---|---|---|---|---|---|---|---|
| | baking | baking | Ashing | Plasma | | | Hot plate | |
| HDI | time | pressure | pressure | power | O₂ | H₂N₂ | Temperature | |
| Wafer | (second) | (Torr) | (Torr) | (W) | (sccm) | (sccm) | (C.) | Result |
| 31P + 6.0E15 | 10 | 760 | 1.5 | 1500 | 2000 | 200 | 230/250/270 | No |
| | | | | | | | | popping |
| 31P + 6.0E15 | 10 | 760 | 1.5 | 1500 | 2000 | 400 | 230/250/270 | No |
| | | | | | | | | popping |
| 31P + 8.0E15 | 10 | 760 | 1.5 | 1500 | 2000 | 500 | 230/250/270 | No |
| | | | | | | | | popping |
| 31P + 8.0E15 | 10 | 760 | 1.5 | 1500 | 2000 | 500 | 230/250/270 | No |
| | | | | | | | | popping |
| 31P + 1.0E16 | 10 | 760 | 1.5 | 1500 | 2000 | 500 | 230/250/270 | No |
| | | | | | | | | popping |
| 31P + 1.0E16 | 10 | 760 | 1.5 | 1500 | 2000 | 500 | 230/250/270 | No |
| | | | | | | | | popping |
| 75As + 3.5E15 | 10 | 760 | 1.5 | 1500 | 2000 | 500 | 230/250/270 | No |
| | | | | | | | | popping |
| 31P + 1.0E14 | 10 | 760 | 1.5 | 1500 | 2000 | 500 | 230/250/270 | No |
| | | | | | | | | popping |
| 75As + 8.0E15 | 10 | 760 | 1.5 | 1500 | 2000 | 500 | 230/250/270 | No |
| | | | | | | | | popping |
| 31P + 1.0E14 | 10 | 760 | 1.5 | 1500 | 2000 | 500 | 230/250/270 | No |
| | | | | | | | | popping |

Conditions such as pressure, microwave, O₂ gas, H₂N₂ gas, temperature as shown in Table 1 have been used for testing whether or not a popping has occurred. When a dopant containing P or As was used under a pressure of 1500 mTorr, in a plasma power of 1500 W, with 2000 sccm of oxygen gas and with an amount of H₂N₂ gas ranging from 200 sccm to 500 sccm, no popping has occurred.

After that, the ashing method as per the present invention was compared with the conventional ashing method in respect to the ashing of via-etching substrates. The process conditions for the conventional method are as shown in Table 2, while the corresponding conditions for the method of the present invention are as shown in Table 3.

TABLE 2

| Ashing | Plasma | | | Hot plate | Processing |
|---|---|---|---|---|---|
| pressure | power | O₂ | N₂ | temperature | Time |
| (Torr) | (W) | (sccm) | (sccm) | (C.) | (second) |
| 1 | 2500 | 7000 | 800 | 250 | 230 |

TABLE 3

| In situ | | | | | | | |
|---|---|---|---|---|---|---|---|
| baking | In situ | Ashing | Plasma | | | Hot plate | Processing |
| pressure | baking time | pressure | power | O₂ | N₂ | temperature | time |
| (Torr) | (second) | (Torr) | (W) | (sccm) | (sccm) | (C.) | (second) |
| 760 | 10 | 1 | 2500 | 7000 | 800 | 250 | 60 |

From the above two Tables, it can be seen that the processing time as per the method of the present invention amounts to 60 seconds, while the corresponding processing time under the same ashing conditions required by the conventional method is 230 seconds.

The scanning electron microscopy (SEM) photos taken after the above processes are shown in FIGS. 9 and 10. While FIG. 9 shows SEM photos after an ashing process in accordance with the conventional method, FIG. 10 shows SEM photos after the in situ baking method as per the present invention has been used. In the above two photos, no significant difference can be detected between the SEM photos as per the conventional method and the SEM photos as per the present method.

Accordingly, the method of the present invention is advantageous in that a popping due to the discrepancy in thermal expansion coefficients of the hard photoresist layer and of the soft photoresist layer at the in situ baking step is prevented, and in that the hard photoresists are removed together with the soft photoresists at the ashing step.

### INDUSTRIAL APPLICABILITY

As described above, the present invention provides an ashing method capable of removing all photoresists, in particular, hardened photoresists, rapidly at the step of ashing without any popping, through an in situ baking of the does ion implanted silicon substrate on a high-temperature hot plate, resulting in an enhancing of the process quantity of the ashing and a reduction in the maintenance costs of the ashing equipment by drastically shortening the processing time.

1. An ashing method comprising:
an in situ baking step, wherein a silicon substrate is baked for a predetermined period of time under a pressure of 10 Torr or more while said silicon substrate is placed on a hot plate;
a vacuumizing step, wherein a stable vacuum status is achieved while said silicon substrate is placed on said hot plate;
a gas processing step, wherein selected reaction gas is introduced into a reaction chamber; and
an ashing step, wherein plasma is generated until almost all of the photoresists are removed.

2. The ashing method as set forth in claim 1, wherein the temperature of said hot plate is from 200° C. through 300° C.

3. The ashing method as set forth in claim 2, wherein the temperature of said hot plate is from 230° C. through 270° C.

4. The ashing method as set forth in claim 1, wherein said predetermined period of time at said in situ baking step is longer than five seconds, but not longer than twenty seconds.

5. The ashing method as set forth in claim 1, wherein said reaction gas comprises one or more of O₂, N₂, H₂N₂, O₃, or CF₄.

6. The ashing method as set forth in claim 1, wherein said silicon substrate is dose ion implanted.

7. The ashing method as set forth in claim 1, wherein said silicon substrate is a via-etched substrate.

8. The ashing method as set forth in claim 1, wherein said silicon substrate is a pad-etched substrate.

9. The ashing method as set forth in claim 1, comprising additionally an over-ashing step, in which plasma is continuously generated even after almost all of the photoresists have been removed by plasma generated at said ashing step.
